(19) United States
(12) Patent Application Publication
(10) Pub. No.: US 2018/0130135 A1
(43) Pub. Date: May 10, 2018

(54) SYSTEM AND METHOD FOR OBTAINING INFORMATION ABOUT A DECEASED PERSON'S LIFE INSURANCE POLICY AND SUBMITTING A CLAIM THEREUNDER

(71) Applicant: Melissa Norwicke, Columbia, NJ (US)

(72) Inventor: Melissa Norwicke, Columbia, NJ (US)

(21) Appl. No.: 15/347,107

(22) Filed: Nov. 9, 2016

(51) Int. Cl. G06Q 40/08; G06Q 50/18

(52) U.S. Cl. CPC G06Q 40/08; G06Q 50/186

(57) ABSTRACT

A business method compiles a national database of life insurance policies, which is searchable by the name and birthdate of a deceased person. Search results identify active life insurance policies owned by the deceased at the time of his/her death and disclose named beneficiaries under each such policy. Disclosed beneficiaries are located and notified of their rights to claim the death benefits under identified policies. The beneficiaries can opt for an additional service that submits one or more death benefits claims on their behalf. A version of the database accessible only to law enforcement officials includes data on the amount of the death benefit payable to each beneficiary, to be used to investigate possible motives for homicides or attempted homicides.

### FIELD OF INVENTION

The present invention relates to the field of searchable databases and business methods associated with the use of such databases, and more particularly to methods for the use of a searchable database of life insurance policies to obtain unclaimed death benefits for policy beneficiaries.

### BACKGROUND OF THE INVENTION

Recent audits of the nation's largest life insurance companies have revealed that billions of dollars of death benefits have gone unpaid because the beneficiaries have never submitted a claim. Most often, this is because the beneficiary is unaware that the policy exists and/or that he/she is a beneficiary under the policy.

When a family member dies, the funeral director will sign a death certificate, which is filed with the state, county and municipal registrars of vital records. Death information is also compiled by the U.S. Social Security Administration in its Death Master File. While insurance companies will use the Death Master File to terminate annuity payments upon the death of a contract holder, they typically don't do the same with respect to notifying beneficiaries of recently deceased life insurance policy holders.

In order to initiate a claim on the deceased's life insurance policy, a beneficiary must submit a certified copy of the death certificate along with required claim forms to the deceased's insurance company. But certain information regarding life insurance policies is protected by federal and state privacy laws, which often require authorization of the policy owner to release such information.

Since there is not an overall database of life insurance policies, potential beneficiaries face a daunting task of searching through the deceased's personal, financial and employment records and making inquiries with hundreds of insurance companies.

While a life insurance policy locator service is offered by MIB Group, Inc., its database only covers life insurance applications submitted to 420 U.S. and Canadian member companies after Jan. 1, 1996. The MIB data does not indicate whether a life insurance policy was ever issued, whether such a policy was in force at the time of the insured's death, or whether any benefits are payable. Even if one or more life insurance applications are located, the MIB data does not include beneficiary information.

Clearly what is needed is a comprehensive national database of active life insurance policies with unclaimed death benefits, and an associated service which would file death benefit claims on behalf of beneficiaries. These are the principal objectives of the present invention.

### SUMMARY OF THE INVENTION

The present invention is a business method which provides a database system for obtaining information about a deceased person's life insurance policy/policies. Optionally, the present invention also provides a service that submits claims for death benefits on behalf of beneficiaries under policies identified by the database.

A national life insurance policy database will be compiled with the cooperation of all major U.S. life insurance companies. Such cooperation will be to the advantage of the insurance companies, which are legally required to make diligent efforts to notify beneficiaries of unclaimed death benefits. The database will not contain the insured's personal or health information which is protected by privacy statutes and regulations, such as HIPAA, but will identify the name and birthdate of each insured, the insurance company, the policy number(s), and the named beneficiaries. Participating insurance companies will notify new and existing insureds of these disclosures and provide them with an opportunity to opt out of the program. The database will be searchable by the name and date of birth of the insured.

Access to the national life insurance policy database will be based on a periodic and/or per-search service fee. Yearly and multi-year service contracts will be offered to business clients, including funeral homes, municipal and county governments, financial advisors, and estate attorneys. Access to the database will be provided to individual users through a website, based on sign-in user name and password. Cloud based database access by business client users will be provided by dedicated application software.

Once the national life insurance policy database has been established and users/clients have been engaged, the system of the present invention will implement the subsequent steps as follows:

(1) Search the database for life insurance policies under the name and birthdate of the deceased;

(2) Extract from the search data: (a) the names and addresses of insurance companies which have active life insurance policies for the deceased, (b) the corresponding life insurance policy numbers, and (c) the names and addresses of the beneficiaries under each life insurance policy;

(3) Locate the named beneficiaries and notify them of their right to submit claims for death benefits under one or more of the identified life insurance policies;

(4) Offer the beneficiaries the opportunity to enlist in the service of filing one or more death benefit claims on their behalf for a specified service fee;

(5) Secure the authorization of each enlisted beneficiary to obtain a certified copy of the deceased's death certificate;

(6) Secure a power of attorney from each enlisted beneficiary to file one or more claims for death benefits under the identified life insurance policies;

(7) For each enlisted beneficiary, obtain a certified copy of the deceased's death certificate;

(8) For each enlisted beneficiary, obtain and complete death benefits claims forms for each of the identified life insurance policies;

(9) For each enlisted beneficiary, submit the completed death benefits claims forms and the certified copy of the deceased's death certificate to the insurance companies for each of the identified life insurance policies; and

(10) For each enlisted beneficiary, complete the claims process for each identified life insurance policy and secure the payment of the corresponding death benefit to the beneficiary.

An alternative embodiment of the present invention would be made available only to law enforcement officials and would also include in the database information on the amount of the death benefit payable to each beneficiary. Law enforcement officials could access such information to investigate possible motives for homicides or attempted homicides.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a flowchart describing an exemplary method providing a searchable national life insurance policy database and an optional death benefit claim service according to one embodiment of the present invention.

### DETAILED DESCRIPTION OF THE PREFERRED EMBODIMENT

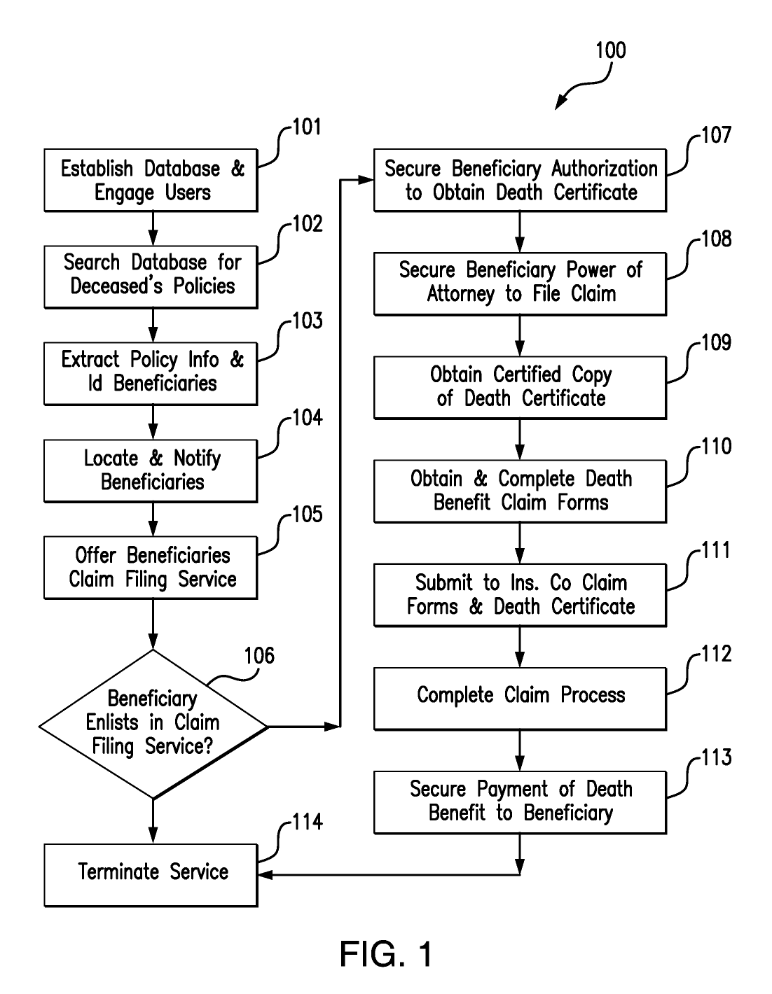

Referring to the flowchart of FIG. 1, an exemplary embodiment of the present invention 100 provides a national life insurance policy database 101, which is searchable by an insured's name and date of birth, and which identifies for each insured the life insurance company, policy number(s) and named beneficiaries. Individual and business users engage for a fee to access the database 101.

Engaged users search the database for active life insurance policies owned by the deceased 102, and extract from the search results relevant information regarding the insurance companies and corresponding policy numbers, as well as names and addresses of beneficiaries under each identified insurance policy 103.

The system then locates and notifies the beneficiaries under each of the deceased's identified life insurance policies 104, and offers each beneficiary the opportunity to participate in a service that files a death benefit claim on behalf of the beneficiary under each identified life insurance policy 105.

If the beneficiary elects to participate in the claim filing service 106, the method carries out steps 107-113, as described hereinafter. If the beneficiary declines the claim filing service 106, the process is terminated 114.

If the beneficiary elects to participate in the claim filing service 106, the next step in the exemplary method secures the participating beneficiary's authorization to obtain a certified copy of the deceased's death certificate 107, which can be requested from the local/municipal registrar of vital documents 109. The system then secures a power of attorney from the beneficiary to file one or more death benefit claims on his/her behalf 108.

After obtaining and completing death benefit claim forms 110, the completed forms and certified copy of the death certificate are submitted as a death benefit claim on behalf of the beneficiary to the insurance company 111. Upon completion of the claim process 112, the system secures payment of the death benefit to the beneficiary 113, and the service is terminated.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A method for identifying active life insurance policies owned by a deceased person and for identifying and notifying one or more death benefit beneficiaries named under each identified life insurance policy, comprising the steps of:
(a) compiling a national database of active life insurance policies, wherein the database is searchable by a name and a birthdate of an insured, and wherein the database identifies for each insured one or more life insurance companies, one or more active life insurance policy numbers corresponding to each identified life insurance company, and one or more death benefit beneficiaries corresponding to each identified life insurance policy number;
(b) providing access to the database to multiple users based on established user fees;
(c) searching the database, by a name and birthdate of the deceased person, for active life insurance policies owned by the deceased person as of a date of the deceased person's death;
(d) extracting from search data generated by the database one or more names and addresses of one or more identified life insurance companies which have active life insurance policies owned by the deceased person;
(e) for each identified life insurance policy, extracting from the search data generated by the database one or more identified life insurance policy numbers corresponding to each identified life insurance company;
(f) for each identified life insurance policy number, extracting from the search data generated by the database one or more names and addresses of one or more identified death benefit beneficiaries corresponding to each identified life insurance policy number; and
(g) notifying each of the identified death benefit beneficiaries of his/her right to submit one or more corresponding death benefit claims to one or more of the identified life insurance companies under one or more of the identified life insurance policy numbers.

2. The method of claim 1, further comprising the steps of:
(h) subscribing one or more of the identified death benefit beneficiaries to a death benefit claim service, wherein the death benefit claim service submits one or more of the corresponding death benefit claims on behalf of each subscribed death benefit beneficiary, and wherein subscriptions to the death benefit claims service are based on established service fees;
(i) securing from each subscribed death benefit beneficiary an authorization to obtain a certified copy of a death certificate of the deceased person;
(j) obtaining for each subscribed death benefit beneficiary the certified copy of the death certificate of the deceased person;
(k) securing from each subscribed death benefit beneficiary a power of attorney to submit the one or more corresponding death benefit claims on behalf of the subscribed death benefit beneficiary;
(l) for each subscribed death benefit beneficiary, obtaining from the identified life insurance company death benefit claim forms for each corresponding death benefit claim and completing the death benefit claim forms;
(m) for each subscribed death benefit beneficiary, submitting to the identified life insurance company the certified copy of the death certificate of the deceased person, the power of attorney, and the completed death benefit claim forms, thereby initiating a claim review process for the corresponding death benefit claim; and
(n) for each subscribed death benefit beneficiary, completing the claim review process for the corresponding death benefit claim and securing payment of a corresponding death benefit to the subscribed death benefit beneficiary.

3. The method of claim 1, further comprising the step of:
(o) providing to multiple law enforcement officials, for the purpose of conducting criminal investigations, access through the database to amounts of death benefits payable to one or more of the identified death benefit beneficiaries corresponding to one or more of the identified life insurance policy numbers.
